(19) United States
(12) Patent Application Publication
(10) Pub. No.: US 2009/0246117 A1
(43) Pub. Date: Oct. 1, 2009

(54) Method of forming a hydrated lime for acid gas removal from flue gas

(76) Inventors: Jean-Yves Tilquin, Villers-le-Bouillet (BE); Louis Masset, Retinne (BE); Bernard Somerhausen, Nivelles (BE)

Correspondence Address: KRATZ, QUINTOS & HANSON, LLP, Greater Beneficial Union of Pittsburgh Building, 4232 Brownsville Road Suite308, Pittsburgh, PA, 15227, US

(21) Appl. No.: 12/079,095

(22) Filed: Mar. 25, 2008

(51) Int. Cl. C01F 11/02

(52) U.S. Cl. 423/640

(57) ABSTRACT

A hydrated lime, especially suited for removal of acid gases, such as SO₃, from flue gases, is produced by the method of hydrating quicklime while controlling the temperature increase of the reaction, caused by the hydration reaction of the quicklime with water, sufficient to form a hydrated lime having a high pore volume of between about 0.1 to 0.25 cm³/g and a specific surface area of between about 20 to 50 m²/g, and then drying the resultant hydrated lime by indirect heating to provide a residual water content of less than 2.0 weight percent of the hydrated lime product.

### FIELD OF THE INVENTION

The present invention is related to a method of forming a dry hydrated lime product, by the hydration of quicklime, which is useful in removing acid gases, and especially sulfur trioxide (SO₃) from flue gases such as those produced by combustion of carbonaceous fuels in power plants.

### BACKGROUND OF THE INVENTION

Environmental concerns exist over the presence of acid gases, such as SO₃, in power plant flue gases which have led to the use of various processes to remove the acid gases prior to discharge of the flue gases to the atmosphere. One useful process involves the use of hydrated lime (Ca(OH)₂) in a dry form to react with the acid gases and remove the same. To enable economical use of such a process, however, it is necessary that the hydrated lime used is in a highly reactive state. Such high reactivity is related to various properties, including a large pore volume and a high specific surface area of the hydrated lime particles used in the acid gas removal process.

Typically, “dry” hydrated lime is produced by mixing water and quicklime in a reactor at a molar ratio of 2 to 2.5 times to produce a hydrated lime product that contains up to 2 percent by weight water. Such a product is useful for injection into a power plant flue gas for reaction with acid gases, such as SO₃, to remove the same from the flue gas prior to discharge of the flue gas to the atmosphere.

There have been processes described that produce artificial stone while using a controlled temperature during the reaction between lime, water and a siliceous and/or argillaceous material. In British patent 593, 648, for example, processes are mentioned where the rate of hydration of lime was retarded by lowering the temperature of water used in the mixture, or by using partially hydrated lime or a mixture of quicklime and hydrated lime, instead of pure quicklime.

In U.S. Pat. No. 5,332,436, also, a method is described where a slaking operation is carried out in the presence of a chemical modifier added to quicklime before hydration or to the water of hydration, so as to produce a hydrate under controlled temperature conditions, so as to increase the surface area of a lime hydrate produced as a wet product having 40-50 percent solids. U.S. Pat. No. 6,395,205 teaches a method of manufacturing an aerated autoclaved concrete material using a modified quicklime that is modified with a chemical modifier, including water, to provide a desired degree of chemical reactivity in a quick-stiffening mixture used.

One example of the production of a hydrated lime product having high reactivity is described in U.S. Pat. No. 6,322,769. In that reference, calcium hydroxide particles are produced that have a moisture content of less than 2 percent, a (BET) specific surface area greater than 30 m²/g, a total nitrogen desorption pore volume of at least 0.1 cm³/g, and a CO₂ content of less than 2 percent. The particles are in the form of a mixture with a first fraction of less than 32 micrometers and 20 to 50 percent of a second fraction of greater than 32 micrometers, where the pores in the particles have a diameter ranging from 100 to 400 Angstroms and a nitrogen desorption pore volume greater than 0.1 cm³/g. The calcium hydroxide particles are produced by slaking CaO particles having a size lower than 5 mm and a reactivity to water of greater than 40° C./min., with sufficient water to obtain hydrated lime with a 15 to 30 percent residual moisture content, drying the hydrated lime by means of a 100-500° C. gas containing a low CO₂ content, and crushing at least a portion of the dried or drying particles to obtain the two fractions of specific sized particles.

It is an object of the present invention to provide a method of forming a hydrated lime that is especially useful in removing acid gases, such as SO₃ from a flue gas.

It is another object of the present invention to provide a method of forming a dry hydrated lime product, that is highly reactive with acid gases, particularly SO₃, due to the presence of a large pore volume and specific surface area of the hydrated lime particles produced, which allows the quicklime fed to a hydrator to have a significant portion thereof of a size greater than 5mm, and use of quicklimes that have varying degrees of reactivity, even below 40° C./min., while producing a hydrated lime product with excellent pore volume and specific surface area characteristics suited for acid gas removal from flue gases.

It is a further object of the present invention to provide a method of forming a hydrated lime that is especially useful in removing acid gases from a flue gas where both high and low reactivity quicklimes can be used to produce a dry hydrated lime having improved pore volume and specific surface area.

### SUMMARY OF THE INVENTION

A dry hydrated lime product that is highly reactive with acid gases, such as SO₃, is produced by the present method from quicklime. The method includes hydrating quicklime while controlling the temperature increase of the reaction, caused by the hydration reaction on the surface of resultant hydrated lime particles, the temperature control sufficient to form a hydrated lime having a high pore volume of between about 0.1 to 0.25 cm³/g and a specific surface area (BET) of between about 20 to 50 m²/g, and then drying the resultant hydrated lime by indirect heating to provide a residual water content less than 2.0 weight percent of the hydrated lime product. The dry hydrated lime particles may then be subjected to a milling step to break down any agglomerates, or such milling can be carried out prior to drying, and provide a product with a fine powder consistency.

The control of the temperature increase caused by the hydration reaction can be effected in a number of ways. One method to control the temperature increase is to provide an amount of water during hydration, such that about 10 to 20 percent by weight water remains in the hydrated lime after hydration. Another method to control the temperature increase is to provide indirect cooling of the reactor in which the hydration is taking place. Yet another method to control the temperature increase is to add a hydration rate retardant to the quicklime prior to the hydration step.

### BRIEF DESCRIPTION OF THE DRAWINGS

The present invention is described, by way of example, referring to the drawings, in which:

FIG. 1 is a graph showing the effect of cooling of a first stage of a three stage hydrator during the quicklime hydration used according to the present method;

FIG. 2 is a graph showing the effect of final product moisture from the hydrator on pore volume of the hydrated product prior to drying;

FIG. 3 is a graph showing the effect of using a quicklime pretreated with water resulting in formation of 10 percent by weight of hydrated lime;

FIG. 4 is a schematic flow chart showing one embodiment of milling in the method of the present invention; and

FIG. 5 is a schematic flow chart showing another embodiment of the milling in the method of the present invention.

### DESCRIPTION OF THE INVENTION

The present method forms a dry hydrated lime product from quicklime, that is especially useful for removing an acid gas, such as SO₃, from flue gases, where various quicklimes of different reactivities can be used as the starting material. The method provides various means of controlling the temperature increase, caused by the hydration of the quicklime with water, with what is believed to be a reduction of the temperature increase on the surface of the resultant hydrated lime particles, with the production of hydrated lime particles having a high pore volume and surface area. The pore volume desired is one between about 0.1 to 0.25 cm³/g and the desired surface area is one between about 20 to 50 m²/g.

The ability of dry hydrated lime particles to remove acid gases, such as SO₃, from gaseous streams is related to the pore volume of the particles, as well as the surface area thereof. We have found that by controlling the rate of the increase in the temperature of the hydration, hydrated lime particles can be produced having the desired pore volume and surface area values, from quicklime of a wide range of reactivity and particle size distribution.

The control of the temperature increase of reaction of quicklime with water can be effected in various ways, such as by using excess water in the hydration, external cooling of the reaction vessel in which the hydration is taking place, the addition of a hydration rate retardant to the quicklime prior to the hydration of the quicklime, or a combination of the above.

In one embodiment of the present method, the control of temperature increase, caused by the hydration reaction of quicklime with water, is effected by indirect cooling of the reactor within which hydration is carried out.

Tests were performed using quicklime having the following physical and chemical properties listed in Table I:

TABLE I

| | Size | | T60 | | | | | | | | |
|---|---|---|---|---|---|---|---|---|---|---|---|
| Plant | Range | | Sec | C % | S % | AI₂O₃ % | Fe₂O₃ % | MgO % | SiO₂ % | Mn₃O₄ % | Notes |
| A | 0-2 | mm | 248 | 0.41 | 0.2 | 0.17 | 0.31 | 1.19 | 0.82 | 0.02 | High S |
| B | 0-2 | mm | 80.5 | 0.59 | 0.02 | 0.07 | 0.09 | 0.9 | 0.27 | 0.02 | Low S |
| C | 0-90 | μm | 23 | 0.57 | 0.02 | 0.09 | 0.06 | 0.4 | 0.86 | 0.01 | |
| D | 0-5 | mm | 77.5 | 0.39 | 0.05 | 0.07 | 0.07 | 0.42 | 0.34 | 0.01 | |
| E | 0-8 | mm | 139 | .15 | .04 | 0.45 | 0.21 | 2.5 | 2.66 | 0.01 | |

T60 is a European Standard (EN 4592) of measuring quicklime reactivity and is defined as the time taken for slaking quicklime to achieve 60° C. from a starting temperature of 20° C. Increasing T60 indicates low quicklime reactivity.

As Table I shows, reactivity (T60) varies widely with the time to achieve 60° C., ranging from only 23 seconds to as long as 248 seconds. The range of particle size for each individual lime is also included. Depending on quicklime reactivity, control of the rate of temperature increase of the hydration reaction can be achieved by employing any of the three or combination of the methods mentioned above to achieve the desired final product pore volume and specific surface area.

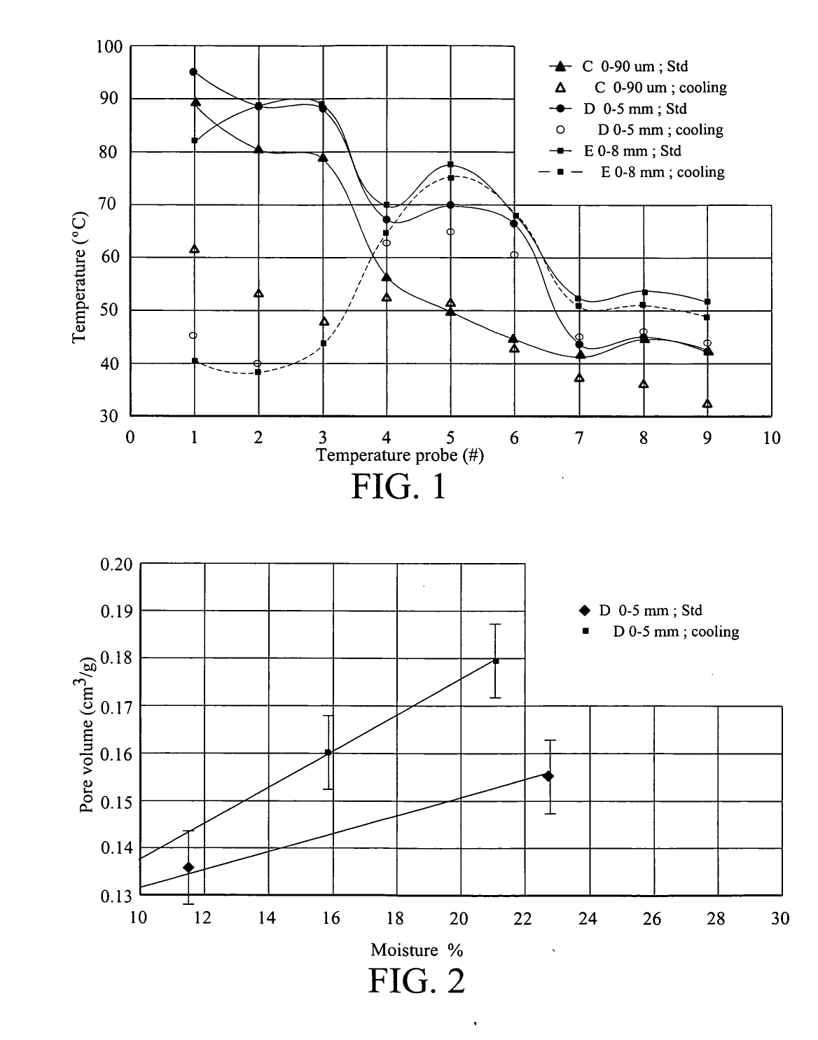

FIG. 1 is a graph showing a temperature profile of several runs of a pilot hydrator with quicklime from three different sources and having different reactivity. Each type of quicklime was processed both with and without utilizing indirect cooling in the first stage of a three stage pilot hydrator as indicated in the legend in FIG. 1. Each of the three stages had three thermocouples located along its length. Thermocouples 1 through 3 were in the first stage, thermocouples 4 through 6 were in the second stage and thermocouples 7 through 9 in the third stage.

The runs where the first stage was not cooled clearly show higher reaction temperatures ranging from 25 to 50° C. higher than the runs where the first stage was cooled. Temperature profiles of stages 2 and 3 of each type of quicklime are very similar regardless of whether the first stage was cooled or not.

Table II shows data from pilot hydrator runs comparing operation with the first stage cooled and without cooling for three selected quick-limes. For clarity, each lime's T60 reactivity data is listed. Lime C is considered highly reactive, while the D and E limes are considered to be medium and low reactive lime respectively.

TABLE II

| | | | | | Surface | |
|---|---|---|---|---|---|---|
| | | | | | Area | Pore |
| Campaign | Lime | Quicklime | Stage 1 | Moisture | (BET) | Volume |
| Reference | Origin | T60 | Cooled | % | m²/g | cm³/g |
| F1 | D | 77.5 | | 0.14 | 21.4 | 0.1116 |
| F2 | D | | | 0.32 | 21.5 | 0.1100 |
| F4 | D | | | 11.64 | 32.3 | 0.1357 |
| F5 | D | | | 22.86 | 30.1 | 0.1551 |
| H1 | D | | Yes | 0.36 | 21.3 | 0.1007 |
| H2 | D | | Yes | 15.94 | 30.7 | 0.1600 |
| H3 | D | | Yes | 21.46 | 31.0 | 0.1796 |
| I1 | C | 23 | | 0.48 | 21.0 | 0.1027 |
| I2 | C | | | 15.04 | 31.6 | 0.1468 |
| I3 | C | | | 24.57 | 30.5 | 0.1680 |
| I4 | C | | | 28.79 | 28.6 | 0.1824 |
| K1 | C | | Yes | 0.44 | 22.4 | 0.1090 |
| K2 | C | | Yes | 22.80 | 29.8 | 0.1674 |
| M2 | E | 139 | | 14.80 | 39.1 | 0.1677 |
| M3 | E | | | 27.57 | 40.5 | 0.1929 |
| N2 | E | | Yes | 14.36 | 34.5 | 0.1539 |
| N3 | E | | Yes | 23.25 | 39.1 | 0.1870 |
| N4 | E | | Yes | 30.79 | 40.3 | 0.1757 |

For low reactive lime (E) there is no enhancement of pore volume when cooling was used in the first stage of the pilot hydrator. Therefore, indirect cooling of the hydrator's first stage would not be considered for such a low reactivity lime. For the medium reactivity D or high reactivity C lime, there is modest to significant enhancement of pore volume seen, particularly with final product moisture greater than 11%. This is seen in FIG. 2. With the error bars indicating ±5% plots for the case of D hydrated lime processed with and without first stage cooling, there appears to be clear improvement in pore volume, particularly as product moisture increases. It is postulated that, for highly reactive lime, local hot spots not measured by thermocouples, can occur even while insuring that excess moisture exists that can keep from achieving the highest possible pore volume. Having first stage cooling in a hydrator that will process high reactive quicklime into hydrated lime is a secondary control parameter, after using excess moisture, to insure production of hydrated lime with the highest possible pore volume. First stage cooling can also produce similar pore volume hydrated lime at lower residual moisture content, reducing energy required to dry the product.

The primary purpose of striving to achieve the highest pore volume and specific surface area is to utilize the hydrated lime in power plant flue gas treatment where increased SO₃ emissions are causing stack opacity problems. A sulfur absorption test has been developed that is useful to compare a particular hydrated lime product's sulfur absorption performance. Table III below compares selected E (low reactive lime), A (extremely low reactive lime) and B (medium reactive lime) hydrates that were dried indirectly and subject to a sulfur (as SO₂) absorption test.

These particular samples represent some extremely low to medium reactivity limes. Regardless of the original lime reactivity it is apparent that through controlling quicklime hydration reaction temperature, by using excess moisture, indirect cooling, or both in the hydrator, pore volume and sulfur absorbed per 100 g sample all track each other closely. That is, hydrating lime, while controlling reaction temperature, leads to greater pore volume that in turn leads to higher sulfur absorbed per unit weight.

It is believed that although high specific surface area is an important characteristic for the hydrated lime product to have, it is secondary to pore volume in importance. From Table III below, the hydrate with the highest specific surface area (BET:SSA) did not have the greatest pore volume nor absorbed the most sulfur per unit mass. It is important for the final hydrated lime product achieve the highest possible sulfur absorption per unit mass so that use of this product can be an economical choice in acid gas removal and that it not add to stack opacity.

TABLE III

| | | | | BJH Cum. | | S |
|---|---|---|---|---|---|---|
| | Quicklime | | BET | Pore Vol. | Moisture | absorbed |
| | Reactivity | D50 | SSA | 5-3000 A | after | per 100 g |
| Lime | T60 | (÷m) | (m²/g) | (cm³/g) | hydrator % | Sample |
| E | 139 | 6.07 | 38.95 | 0.1603 | 15 | 6.03 |
| E | 139 | 12.74 | 36.75 | 0.1978 | 23 | 6.72 |
| A | 248 | 18.49 | 31.84 | 0.1952 | 24 | 6.94 |
| B | 80.5 | 14.22 | 31.37 | 0.1514 | 17 | 5.9 |

The hydration of quicklime to produce a dry hydrated lime is generally effected by using 2 to 2.5 times excess of water over the stoiciometric amount required. In one embodiment of the present method, an excess of water, about ten percent to twenty percent in the resultant hydrated lime, is used so as to control the temperature increase caused by the hydration reaction.

Where excess water is added, it should not be an amount that results in more than about 20 percent by weight water in the resultant hydrated lime, as clogging of the hydration reactor can result.

A further embodiment of the present method is to control the temperature increase, caused by the hydration reaction of quicklime with water, by adding a hydration rate retardant to the quicklime prior to the hydration of the quicklime.

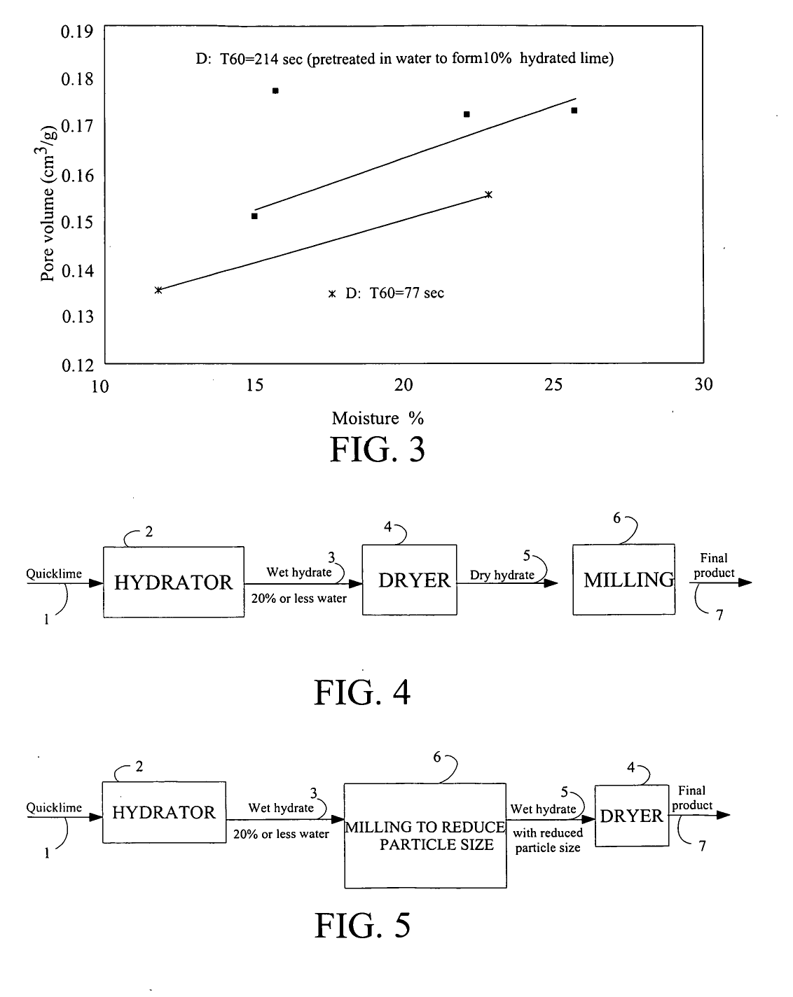

FIG. 3 illustrates the effect of adding water as a hydration rate retardant, with a small amount of water added to the quicklime prior to the full hydration, such that about 10 percent by weight of already prehydrated lime is present in quicklime D, which reduces the reactivity (T60) from 77.5 sec to 214 sec.

The hydration rate retardant can be a small amount of water, such as 0.05 to 0.3 of the stiochiometric amount for hydration, added to the quicklime prior to passage to a hydration reactor for complete hydration of the quicklime and then passing the resultant adulterated quicklime to the hydration reactor. The small amount of water added prior to full hydration is believed to coat the quicklime particles and retard the rate of hydration to lead to the properties desired. Or, other chemicals could be added to the quicklime, so as to coat partially the quicklime particles, to act as a hydration rate retardant, in the nature of a chemical modifier.

After the hydration of the quicklime to give a hydrated lime having a pore volume of between about 0.1 to 0.25 cm³/g and a specific surface area of between about 20-50 m²/g, the hydrated lime is dried by indirect heating to provide a residual water content of less than 2 weight percent of the hydrated lime product. Such indirect drying can be effected in a simple flash or fluid bed dryer, or the like, that will not cause pore volume and specific surface area of the resultant hydrated lime to deteriorate.

As shown in Table IV, with the use of quicklime E, the final moisture content of the resultant hydrated lime, after drying, significantly effects to the hydrate performance during injection into an SO³-containing gaseous stream.

TABLE IV
SO₂ Capture/Adsorption

| | | S Absorbed/100 g |
|---|---|---|
| | | of Starting |
| Sample ID | Moisture % | Sample |
| Run A | 2.76% | 4.00 |
| Run B | 0.08% | 6.70 |
| Run C | 0.01% | 6.89 |
| Run C Repeat | 0.01% | 6.79 |
| Run D | 0.23% | 5.81 |
| Typical | 0.5%-2.00% | 3.4-4.2 |

FIG. 4 schematically illustrates the method of the present invention where quicklime is introduced through line 1 to a hydrator 2 where quicklime and water are combined, while controlling the temperature of the reaction, to form a resultant hydrated lime having a high pore volume of between about 0.1 to 0.25 cm³/g and a specific surface area of between about 20 to 50 m²/g. The resultant hydrated lime, containing a residual water content of 20% or less water, is passed through line 3 to an indirect drying unit 4, wherein water content of the resultant hydrated lime is decreased to a value of less than 2.0 weight percent. The dry hydrate may then be passed through line 5 to a milling unit 6 to break up any agglomerates and/or reduce particle size present, and the hydrated lime product removed through line 7. As an alternative, and as illustrated schematically in FIG. 5, the breaking up of agglomerates may be carried out on the resultant hydrated lime prior to passage of the hydrated lime to the indirect drying unit.

The resultant hydrated lime produced in the hydrator may contain agglomerates that should be broken up or dispersed. Any such agglomerates may be dispersed into particulate form after drying or the same may be dispersed into particulate form prior to or during drying. A milling device, such as a hammer mill or the like, may be used to disperse the agglomerated material, without impacting performance of the product.

We claim:

1. A method of forming a dry hydrated lime product, that is highly reactive with acid gases, such as SO₃, from quicklime comprising:
hydrating quicklime while controlling the temperature increase of the reaction, caused by the hydration reaction of the quicklime with water, sufficient to form a hydrated lime having a high pore volume of between about 0.1 to 0.25 cm³/g and a specific surface area of between about 20 to 50 m²/g, and then drying the resultant hydrated lime by indirect heating to provide a residual water content of less than 2.0 weight percent of the hydrated lime product.

2. The method of forming a hydrated lime product as defined in claim 1, wherein the controlling of the temperature increase is effected by indirect cooling of the reactor within which the hydration is carried out.

3. The method of forming a hydrated lime product as defined in claim 2, wherein the reactor comprises a plurality of stages of mixing of the quicklime with the water and the indirect cooling is effected in a first stage or subsequent stage or both.

4. The method of forming a hydrated lime product as defined in claim 2, wherein the reactor comprises a plurality of stages of mixing of the quicklime with the water and the indirect cooling is effected only in a first stage of cooling.

5. The method of forming a hydrated lime product as defined in claim 1, wherein the controlling of the temperature increase is by providing a sufficient amount of water during the hydration so as to result in up to about 20 percent by weight of water in the resultant hydrated lime prior to drying thereof.

6. The method of forming a hydrated lime product as defined in claim 5, wherein the amount of water in the resultant hydrated lime is between about 10 percent to 20 percent by weight.

7. The method of forming a hydrated lime product as defined in claim 1, wherein the controlling of the temperature increase is effected by adding a hydration rate retardant to the quicklime prior to passage thereof to a hydration reactor.

8. The method of forming a hydrated lime product as defined in claim 7, wherein the hydration rate retardant is water.

9. The method of forming a hydrated lime product as defined in claim 1, wherein any agglomerates of the resultant hydrated lime product, after drying, are dispersed into particulate form.

10. The method of forming a hydrated lime product as defined in claim 1, wherein any agglomerates of the resultant hydrated lime are dispersed into particulate form prior to or during drying.

11. The method of forming a hydrated lime product as defined in claim 1, wherein the residual water content of the hydrated lime product is less than 0.1 weight percent.

12. The method of forming a hydrated lime product as defined in claim 1, wherein the quicklime has a particle size greater than 5 mm and a reactivity to water of greater than 40° C./min.
